(19) United States
(12) Patent Application Publication
(10) Pub. No.: US 2014/0109776 A1
(43) Pub. Date: Apr. 24, 2014

(54) JUICE EXTRACTOR

(71) Applicant: Young Ki Kim, Gyeongsangnam-do (KR)

(72) Inventor: Young Ki Kim, Gyeongsangnam-do (KR)

(21) Appl. No.: 14/122,925

(22) PCT Filed: Mar. 29, 2012
(86) PCT No.: PCT/KR2012/002329

§ 371 Date: Dec. 20, 2013

(30) Foreign Application Priority Data
Jun. 14, 2011 (KR) 10-2011-0057565

(51) Int. Cl. A23N 1/02

(52) U.S. Cl. CPC A23N 1/02
USPC 99/513

(57) ABSTRACT

A juice extractor having a catching groove that is axially formed on an inner surface of the discharging net in a residue discharging direction, so that residue can be efficiently discharged in the residue discharging direction by the rotation of spiral teeth.

### TECHNICAL FIELD

The present invention relates to a juice extractor that can make juice from vegetables or fruits.

### BACKGROUND ART

In recent years, with the increased interest in well-being, many people are personally making green vegetable juice or fruit juice from fresh vegetables or fruits. Thus, there are various juicers for making fruit juice and green vegetable juice that are available and whose purpose is to easily make fruit juice or green vegetable juice at home.

An example of such a juice extractor is the one proposed in Korean Patent No. 609390, which was filed by the applicant of this invention and registered. FIG. 1 is a sectional view showing the configuration of a conventional juice extractor. As shown in FIG. 1, the juice extractor 1 is configured so that a long feed screw 30 is horizontally assembled in a housing 10, together with a strainer 40, to be coupled to a sidewall of a driving unit by a rotating shaft 31. When the material used to make the juice is put into a feed port 21 of a hopper and reaches a lower end of a feed tube 20, the feed screw 30 slowly feeds the material horizontally while extracting juice.

In the conventional juice extractor disclosed in Korean Patent No. 609390, the discharging net 42 of the strainer is configured to have a flat smooth surface. In the discharging net 42, residue from which juice has been extracted is compressed under a substantial pressure between the spiral teeth and the discharging net 42, so that a part of the residue may not be easily fed in the discharging direction, but merely rotates together with the spiral teeth 33 inside the flat smooth surface of the discharging net 42 and, accordingly, the juice extraction process of the juice extractor may not take place efficiently as desired.

### DISCLOSURE OF INVENTION

### Technical Problem

Accordingly, the present invention has been made keeping in mind the above problems occurring in the related art, and a purpose of the present invention is to propose a juice extractor which is configured in such a way that the residue can be easily discharged in a discharging direction by a rotation of spiral teeth of a feed screw.

### Solution to Problem

In order to achieve the above object, according to one aspect of the present invention, there is provided a juice extractor including: a housing having a juice discharge port formed in a lower part thereof and an interior space defined therein; a strainer placed in the interior space of the housing and having both a crushing part and a discharging net a feed screw placed in the strainer and rotating in such a way that a rotating screw bar, which has spiral teeth and forms a part of the feed screw, can be rotated horizontally and a housing cap assembled with a control cap, wherein a catching groove is axially formed on an inner surface of the discharging net in a residue discharging direction.

Further, in the juice extractor of the present invention, the spiral teeth are rotated in a state in which they are in close contact with the inner surface of the discharging net.

### Advantageous Effects of Invention

As described above, the juice extractor of the present invention includes: the housing having the juice discharge port formed in the lower part thereof and the interior space defined therein; the strainer placed in the interior space of the housing and having both the crushing part and the discharging net the feed screw placed in the strainer and rotating in such a way that the rotating screw bar, which has the spiral teeth and forms a part of the feed screw, can be rotated horizontally and the housing cap assembled with the control cap, wherein the catching groove is axially formed on the inner surface of the discharging net in the residue discharging direction, so that the residue can be easily discharged in the residue discharging direction by the rotation of the spiral teeth.

Further, in the present invention, the spiral teeth are rotated in a state in which they are in close contact with the inner surface of the discharging net, so that the spiral teeth can effectively wipe the residue on the inner surface of the discharging net and, at the same time, the residue can be easily fed in the discharging direction by being prevented from rotating together with the spiral teeth, thereby being easily discharged in the discharging direction by the rotation of the spiral teeth.

### BRIEF DESCRIPTION OF DRAWINGS

The above and other objects, features and further advantages of the present invention will be more clearly understood from the following detailed description when taken in conjunction with the accompanying drawings, in which:

FIG. 1 is a sectional view illustrating the construction of a conventional juice extractor;

FIG. 2 is an exploded perspective view illustrating the construction of a juice extractor according to the present invention;

FIG. 3a is a sectional view illustrating the construction of the juice extractor according to the present invention;

FIG. 3b is a sectional view illustrating a state in which the soft elastic body of the juice extractor according to the present invention is being compressed and

FIG. 4 is a sectional view taken along line A-A of FIG. 2.

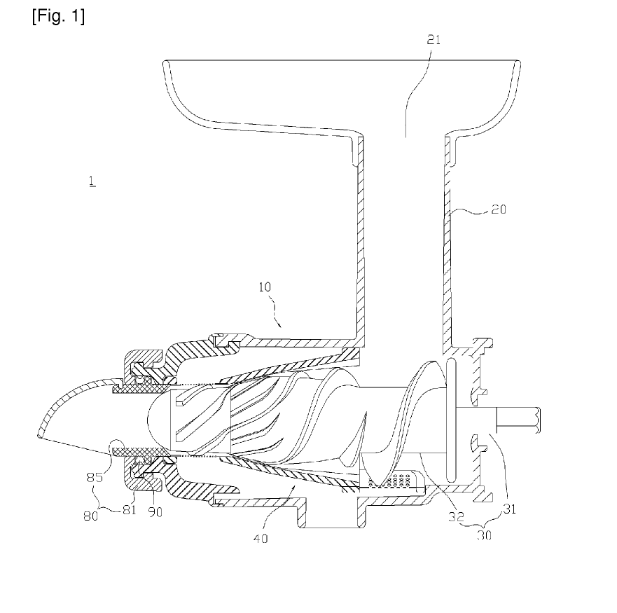

### MODE FOR THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of my invention shown and described herein is to be taken as a preferred embodiment of the present invention and that various changes and modifications may be made in the invention without departing from the spirit and scope thereof.

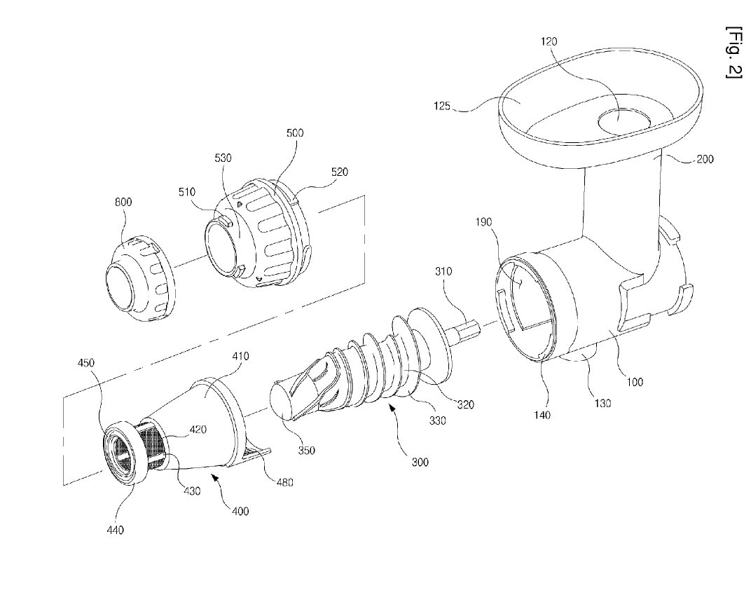

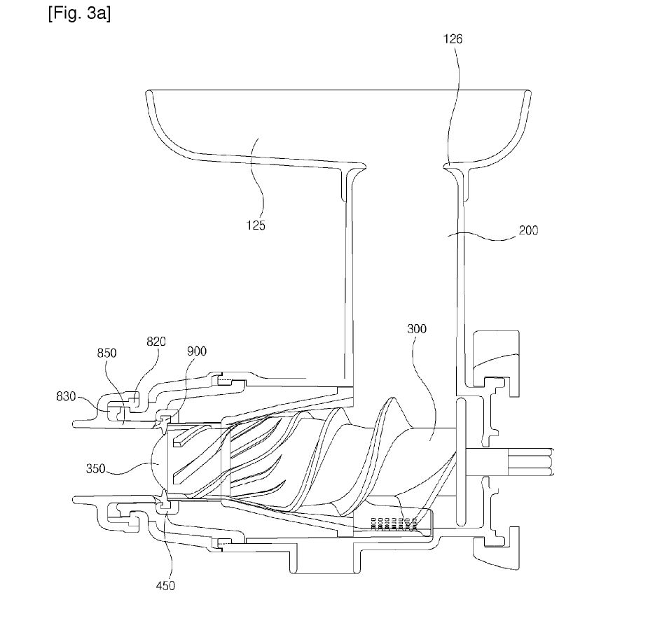

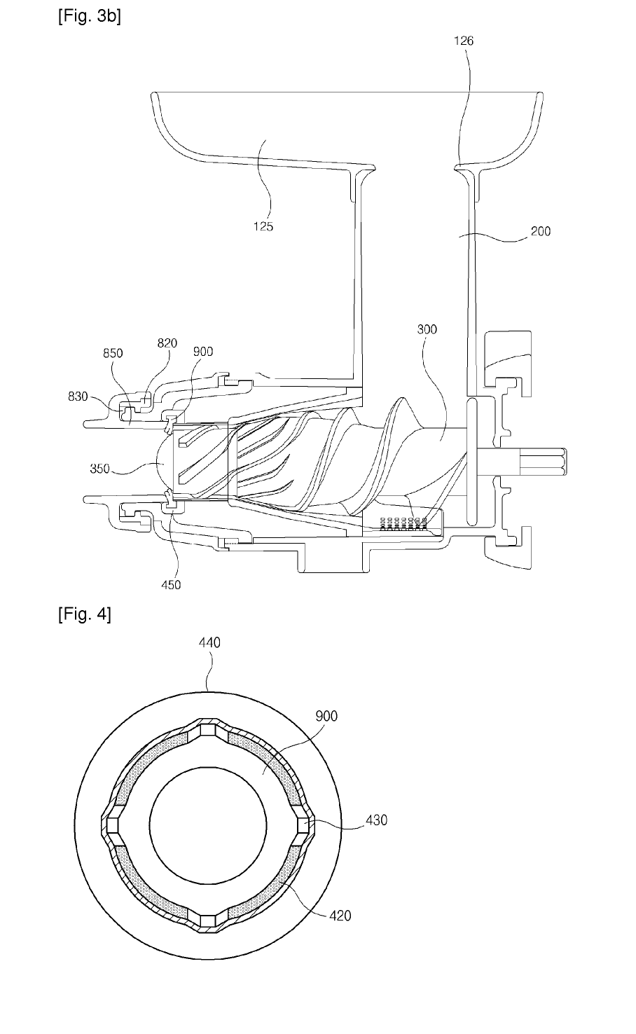

As shown in FIGS. 2, 3a and 3b, the present invention provides a juice extractor including: a housing having a juice discharge port formed in a lower part thereof and an interior space defined therein; a strainer placed in the interior space of the housing and having both a crushing part and a discharging net a feed screw placed in the strainer and rotated in such a way that a rotating screw bar thereof can be rotated horizontally, with spiral teeth being formed around the rotating screw bar and a housing cap assembled with a control cap, wherein a catching groove is axially formed on an inner surface of the discharging net in a residue discharging direction.

Further, in the juice extractor of this invention, the spiral teeth are rotated in a state in which they are in close contact with the inner surface of the discharging net.

FIG. 2 is an exploded perspective view illustrating the construction of a juice extractor according to the present invention. As shown in FIG. 2, the juice extractor includes a housing 100, a feed screw 300, a strainer 400, a housing cap 500 and a control cap 800.

A feed tube 200 assembled with a hopper 125 is provided on the upper end of the housing 100, while a juice discharge port 130 for discharging juice is formed in a bottom of the housing 100, with an interior space 190 being defined inside the housing 100. The interior space 190 has a cylindrical shape and is preferably open in left and right ends. Further, in the left end of the housing 100 defining the interior space 190 therein, housing locking ribs 140 are provided so as to fasten the housing cap 500 to the housing 100. Further, a feed port 120 into which is put the material used to make the juice is formed in the upper end of the feed tube 200.

The feed screw 300 includes: a rotating shaft 310 that protrudes outside from the right end of the housing 100 and receives a drive force from a driving device, such as an external motor (not shown), and a rotating screw bar 320 integrated with the rotating shaft 310 into a single body. The feed screw 300 is horizontally placed in the housing interior space 190 in such a way that the rotating screw bar 320 can be rotated horizontally, with spiral teeth 330 being formed around the rotating screw bar 320 so as to feed and crush the input material.

The strainer 400 includes a crushing part 410 and a discharging net 420 and is placed horizontally in the interior space of the housing 100. The crushing part 410 has a hollow conical shape and is placed so as to surround the feed screw 300, so that the crushing part 410 guides the input material that has been fed forwards (leftwards) by the feed screw 300, thereby crushing the material. The juice produced in the crushing part 410 by the crushing function of the feed screw 300 flows to the juice discharge port 130 through a filtering net 480 that is provided in a rear end of the crushing part 410, and is then discharged to the outside through the juice discharge port 130. The discharging net 420 extends forwards (leftwards) from the crushing part 410 and comes into contact with the outer surface of the distal end 350 of the feed screw 300 and discharges the residue of the material to the outside.

Catching grooves are axially formed in the inner surface of the discharging net 420 in a residue discharging direction. Here, it is preferred that the spiral teeth 330 be configured such that they are rotated in a state in which they are in close contact with the inner surface of the discharging net.

The left end surface of the strainer 400 is provided with a side ring 440. In the side ring 440, a ring insert groove 450 for holding a part of a soft elastic ring 900 is formed.

The housing cap 500 is provided with a central opening. Locking protrusions 520 for fastening the housing cap 500 to the housing locking ribs 140 of the housing 100 are formed around an outer circumferential surface of one end of the housing cap 500, while a flange 530 over which the control cap 800 is fitted is formed in the end of the housing cap 500. Further, taper protrusions 510 are formed around the outer circumferential surface of the flange 530.

In the control cap 800, a cylindrical control part 850 having a central opening is formed. A recessed part 830 is formed around the cylindrical control part 850, so that the flange 530 is fitted into the recessed part 830. On the inner surface of the recessed part 830, inclined surface protrusions 820 having respective inclined surfaces are formed and engage with the taper protrusions 510. Here, the inclined surface protrusions 820 are inclined in circumferential directions in such a way that when the control cap 800 is rotated, the control cap 800 can be moved to the left or right by the cooperation of the inclined surface protrusions 820 and the taper protrusions 510, as shown in FIGS. 3a and 3b.

Here, the cylindrical control part 850 and the recessed part 830 of in the control cap 800 may be integrated into a single body.

The soft elastic body 900 has a ring shape and is held by the side ring 440 that is formed on the end of the strainer 400. Here, it is preferred that the soft elastic body 900 be inserted into the ring insert groove 450 formed in the side ring 440, so that the soft elastic body 900 can be continuously retained at the desired location.

The operation of the juice extractor according to the present invention will be described hereinbelow.

When the material used to make juice is put into the feed port 120 that is formed in the feed tube 200 of the juice extractor 100, the input material is fed to the left in the housing 100 by the feed screw 300. When the input material is fed to the left, the material is crushed between the feed screw 300 and the crushing part 410 and juice produced by the crushing operation flows to the juice discharge port 130 through the filtering net 480 that is provided in the rear end of the crushing part 410.

The material that has been processed by the crushing part 410 is continuously fed forwards by the rotation of the feed screw 300 and is discharged to the outside via the discharging net 420 by the rotating of the feed screw 300.

When the control cap 800 that is rotatably fitted over the front end of the housing cap 500 is rotated, the control cap 800 is moved forwards or backwards relative to the housing cap 500 by the function of the inclined surfaces of the inclined surface protrusions 820 that are formed on the control cap 800 and are engaged with the taper protrusions 510 of the housing cap 500, so that the cylindrical control part 850 of the control cap 800 compresses or releases the soft elastic ring 900 and changes the force compressing the distal end 350 of the feed screw 300, thereby controlling the residue discharging force of the juice extractor. In other words, a user can finely control the residue discharging force of the juice extractor by rotating the control cap 800 according to a kind of input material.

As described above, the material that has been processed while being fed to the front of the juice extractor by the rotation of the feed screw 300 passes through the cylindrical control part 850 and is discharged downwards from the front end of the juice extractor.

Further, the juice extractor of this invention is configured in such a way that the spiral teeth 330 are rotated in a state in which they are in close contact with the inner surface of the discharging net 420. Accordingly, the residue can be caught by the catching grooves 430, thereby being fed in the rotating direction of the feed screw and being discharged in the residue discharging direction by the rotation of the spiral teeth 330. Therefore, the catching grooves 430 prevent the residue from being rotated together with the spiral teeth 330, but efficiently discharge the residue in the residue discharging direction, thereby realizing efficient feeding of the residue.

Further, in the present invention, the spiral teeth 330 are rotated in a state in which they are in close contact with the inner surface of the discharging net, thereby wiping the residue from the inner surface of the discharging net. Further, the catching grooves are formed on the inner surface of the discharging net with which the spiral teeth are in close contact, so that the catching grooves can prevent the residue from being rotated together with the spiral teeth, but efficiently feed the residue in the residue discharging direction. Therefore, in the present invention, the rotation of the spiral teeth can efficiently discharge the residue in the residue discharging direction.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A juice extractor, comprising: a housing having a juice discharge port formed in a lower part thereof and an interior space defined therein; a strainer placed in the interior space of the housing and having both a crushing part and a discharging net a feed screw placed in the strainer and rotated in such a way that a rotating screw bar, which has spiral teeth on a periphery thereof, of the feed screw can be rotated horizontally and a housing cap assembled with a control cap, wherein a catching groove is axially formed on an inner surface of the discharging net in a residue discharging direction.

2. The juice extractor as set forth in claim 1, wherein the spiral teeth are rotated in a state in which the teeth are in close contact with the inner surface of the discharging net.
